(19) United States
(12) Patent Application Publication
(10) Pub. No.: US 2021/0130195 A1
(43) Pub. Date: May 6, 2021

(54) Heavy Metal Separating Device and Parameter Determining Method

(71) Applicant: Nanchang Hangkong University, Jiangxi (CN)

(72) Inventors: Xubiao Luo, Jiangxi (CN); Jiawei Nie, Jiangxi (CN); Penghui Shao, Jiangxi (CN); Liming Yang, Jiangxi (CN); Hui Shi, Jiangxi (CN); Yanxi Liu, Jiangxi (CN)

(21) Appl. No.: 17/004,748

(22) Filed: Aug. 27, 2020

(30) Foreign Application Priority Data
Nov. 5, 2019 (CN) 201911069663.8

(51) Int. Cl. C02F 1/28; C02F 1/00

(52) U.S. Cl. CPC C02F 1/28; C02F 2101/20; C02F 1/008

(57) ABSTRACT

The present invention discloses a heavy metal separating device and a parameter determining method. The device includes a plurality of pipe sections and a plurality of adsorbents; the pipe sections each include multilayer pipes; the plurality of pipe sections are connected end to end; each of the pipe sections is coated with one adsorbent; and the adsorbent is coated onto the multilayer pipes of the pipe section. According to the present invention, the adsorbents are coated onto the pipes and supporting plates, so that heavy metals are separated in the wastewater conveying process, the area occupied by wastewater treatment facilities can be greatly reduced, and heavy metal ions in the wastewater can be efficiently separated.

### TECHNICAL FIELD

The present invention relates to the field of industrial wastewater treatment, and in particular, to a heavy metal separating device and a parameter determining method.

### BACKGROUND

Heavy metal-containing wastewater mainly comes from mining, metallurgy, machinery manufacturing, chemical engineering, electronics, pesticides, paint, fuel, instruments and other industries. Heavy metals unnecessary for our activities, such as lead, cadmium, mercury, chromium and metalloid arsenic, have significant toxicity to human beings, animals, plants and microorganisms. These heavy metals cannot be degraded by microorganisms, and can easily accumulate in organisms, and especially in human bodies, resulting in significant toxic effects. Heavy metals, such as lead, cadmium, mercury, chromium and metalloid arsenic, are one class of pollutants with the most serious environmental pollution and the greatest harm to human beings. Drinking water polluted by heavy metals for a long time may cause cardiovascular, pulmonary, neurological and endocrine disorders and cancers even if there is a low concentration of heavy metals. High intake will irritate the central nervous system and severely damage the kidney and liver. For example, cadmium (II) ions may cause kidney damage, and copper (II) ions may cause liver injury or Wilson's disease, while nickel (II) ions may cause dermatitis or chronic asthma. China is still in rapid economic development. There are increasing activities of mining and dressing, smelting and machining of heavy metals and manufacturing products. The problem of heavy metal pollution becomes increasingly prominent and shows a trend of high incidence. According to incomplete statistics, the annual discharge of heavy metal wastewater in China amounts to about 4 billion tons, and the pollution rate of sediments in rivers, lakes and reservoirs is as high as 80.1%. The problem of heavy metal pollution in water bodies is very prominent. Heavy metal pollution has become a major global environmental problem. The prevention and control of heavy metal pollution has always been a difficulty and research hotspot in the international environmental protection field. Heavy metals cannot be degraded by microorganisms, the pollution to environmental media features concealment, long term and accumulation, etc., and so far no universal and effective treatment method has been found. Therefore, there is an urgent need to vigorously develop a heavy metal pollution control technology to deal with the increasingly serious heavy metal pollution.

Existing heavy metal ion removal methods include a chemical precipitation method, an ion exchange method, a redox process, a membrane separation process, a flotation process, etc. These methods have, to different extents, the disadvantages of requiring large energy consumption, high investment, complicated operations and large occupied area and easily causing secondary pollution, etc.

### SUMMARY

The present invention provides a heavy metal separating device and a parameter determining method, which greatly reduce the area occupied by wastewater treatment facilities and can efficiently separate heavy metal ions in water. To achieve the above purpose, the present invention provides the following technical solutions.

A heavy metal separating device is provided, including a plurality of pipe sections and a plurality of adsorbents; A heavy metal separating device is provided, including a plurality of pipe sections and a plurality of adsorbents;

where the pipe sections each include multilayer pipes;

the plurality of pipe sections are connected end to end; and

each of the pipe sections is coated with one adsorbent; and the adsorbent is coated onto the multilayer pipes of the pipe section.

Optionally, a plurality of supporting plates are arranged between adjacent pipes of the pipe section; and the supporting plates are coated with the adsorbents.

Optionally, the heavy metal separating device further includes a plurality of connectors;

where the plurality of the pipe sections are connected by the connectors.

Optionally, the heavy metal separating device further includes a plurality of on-line water quality monitoring devices;

where the connector is provided with a water quality monitoring port; a probe of the on-line water quality monitoring device is arranged inside the connector through the water quality monitoring port; the on-line water quality monitoring device is used for detecting and displaying the concentration of heavy metal ions in wastewater flowing into the connector.

A parameter determining method for a pipe section of the above heavy metal separating device is further provided, including:

according to a design flow of the pipe section and codes for design of outdoor wastewater engineering, determining a relation between a diameter of the pipe section and a depth of wastewater in the pipe section;

setting an initial value of the diameter of the pipe section as a minimum pipe diameter threshold specified in the codes for design of outdoor wastewater engineering;

according to the relation, calculating the wastewater depth corresponding to the pipe section diameter;

determining fullness of the pipe section according to the depth of wastewater;

according to the diameter of the pipe section, obtaining maximum design fullness corresponding to the diameter of the pipe section by looking up a relation table of the pipe diameter and the maximum design fullness;

determining whether the fullness is greater than the maximum design fullness to obtain a first determining result;

if the first determining result indicates that the fullness is greater than the maximum design fullness, increasing the diameter of the pipe section to obtain an updated pipe section diameter, and returning to the step of calculating the wastewater depth corresponding to the pipe section diameter according to the relation;

if the first determining result indicates that the fullness is less than or equal to the maximum design fullness, outputting the pipe section diameter as a diameter value of the pipe section; and

according to the diameter value of the pipe section and preset ratios of radiuses of the multilayer pipes, determining the number of pipe layers of the pipe section and the diameter of each pipe layer.

Optionally, the determining a relation between a diameter of the pipe section and a depth of wastewater in the pipe section according to a design flow of the pipe section and codes for design of outdoor wastewater engineering specifically includes: according to the design flow of the pipe section and the codes for design of outdoor wastewater engineering, determining the relation between the diameter of the pipe section and the depth of wastewater in the pipe section as follows:

$$\begin{matrix}Q = A υ \\ A = 2 \times [ \frac{π - θ}{2} \times {( \frac{D}{2} )}^{2} + \frac{1}{2} \times \frac{D}{2} \times ( h - \frac{D}{2} ) \times \frac{h - \frac{D}{2}}{D / 2} ] & 1. \\ υ = \frac{1}{n} {R}^{\frac{2}{3}} {I}^{\frac{1}{2}} & 1.\end{matrix}$$

where Q is the design flow of the pipe section, A is an effective cross-sectional area of water in the pipe section, υ is a flow rate of water in the pipe section, n is a roughness coefficient of the pipe section, I is a hydraulic slope of water in the pipe section, R is a hydraulic radius of water in the pipe section,

$$R = \frac{A}{χ} ,$$

χ is a wetted perimeter of the pipe section,

$$χ = \frac{2 π - 2 θ}{2 π} \times π D ,$$

2θ is a central angle of the water surface in the pipe section,

$$θ = arccos \frac{h - \frac{D}{2}}{D \text{/} 2} ,$$

h is the depth of wastewater in the pipe section, and D is the diameter of the pipe section.

Optionally, the determining fullness of the pipe section according to the depth of wastewater specifically includes:

calculating fullness of the pipe section by using formula

$$ω = \frac{h}{D}$$

according to the depth of wastewater; where ω is the fullness of the pipe section, h is the depth of wastewater in the pipe section and D is the diameter of the pipe section.

Optionally, the determining the number of pipe layers of the pipe section and the diameter of each pipe layer according to the diameter value of the pipe section and preset ratios of radiuses of the multilayer pipes specifically includes:

setting an initial value of the preset number of pipe layers to 1;

according to the diameter value of the pipe section and the preset ratios of radiuses of the multilayer pipes, determining the radius of the innermost pipe corresponding to the number of pipe layers;

determining whether the radius of the innermost pipe is greater than 200 mm to obtain a second determining result;

if the second determining result indicates that the radius of the innermost pipe is greater than 200 mm, increasing the number of pipe layers by 1, and returning to the step of determining the radius of the innermost pipe corresponding to the number of pipe layers according to the diameter value of the pipe section and the preset ratios of radiuses of the multilayer pipe;

if the second determining result indicates that the radius of the innermost pipe is less than or equal to 200 mm, outputting the number of pipe layers; and according to the number of layers of the pipe, the diameter value of the pipe section and the preset ratios of radiuses of the multilayer pipes, determining the diameter of each pipe layer of the pipe section.

According to specific examples provided by the present invention, the present invention has the following technical effects.

According to the present invention, an adsorbent is coated onto a drainage pipe section, so that heavy metal ions are separated while wastewater is transported, and the area occupied by wastewater treatment facilities is greatly reduced. In addition, the pipe section is provided with multilayer pipes and a plurality of supporting plates, and the pipe walls of the multilayer pipes and both surfaces of the plurality of supporting plates are coated with adsorbents, so that the contact area between wastewater and the adsorbents is increased, and heavy metal ions in the wastewater can be efficiently separated.

### BRIEF DESCRIPTION OF THE DRAWINGS

To describe the technical solutions in the examples of the present invention or in the prior art more clearly, the following briefly describes the accompanying drawings required for the examples. Apparently, the accompanying drawings in the following description show merely some examples of the present invention, and a person of ordinary skill in the art may still derive other accompanying drawings from these accompanying drawings without creative efforts.

FIG. 1 is a structural diagram of a heavy metal separating device according to the present invention; and

FIG. 2 is a graph showing a relation between a diameter of a pipe section and a depth of wastewater in the pipe section according to the present invention.

Symbol description: 1. pipe section, 2. pipe, 3. connector, 4. supporting plate, 5. adsorbent, 6. water quality monitoring port.

### DETAILED DESCRIPTION

The following clearly and completely describes the technical solutions in the examples of the present invention with reference to accompanying drawings in the examples of the present invention. Apparently, the described examples are merely some rather than all of the examples of the present invention. All other examples obtained by a person of ordinary skill in the art based on the examples of the present invention without creative efforts shall fall within the protection scope of the present invention.

The present invention provides a heavy metal separating device and a parameter determining method, which greatly reduce the area occupied by wastewater treatment facilities and can efficiently separate heavy metal ions in wastewater.

In order to make the foregoing objectives, features, and advantages of the present invention more understandable, the present invention will be further described in detail below with reference to the accompanying drawings and detailed examples.

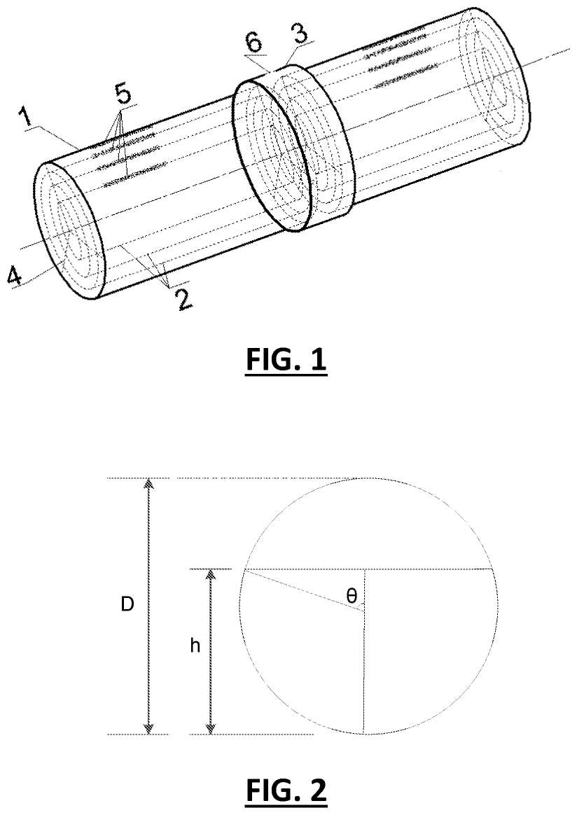

An example of the present invention provides a heavy metal separating device. As shown in FIG. 1, the device includes a plurality of pipe sections 1 and a plurality of adsorbents 5.

The pipe sections 1 each include multilayer pipes 2; the plurality of pipe sections 1 are connected end to end; each of the pipe sections 1 is coated with one adsorbent 5; and the adsorbent 5 is evenly coated onto the multilayer pipes 2 of the pipe section 1.

Preferably, the adsorbent 5 is a heavy metal ion adsorbent with a fast adsorption rate, good selectivity and large adsorption capacity. The adsorbent 5 is uniformly coated onto pipe walls of the multilayer pipes 2 of each of the pipe sections 1, and each adsorbent 5 is used for adsorbing a certain heavy metal ion in wastewater. Since only one adsorbent 5 is coated in each of the pipe sections 1, the number of the pipe sections 1 is consistent with the number of types of heavy metal ions in wastewater. In actual use, the number of the pipe sections 1 can be increased or decreased according to the number of types of heavy metal ions to be treated in wastewater.

A plurality of supporting plates 4 are arranged between adjacent pipes 2 of the pipe section 1; the supporting plates 4 are coated with the adsorbents 5; and the pipe 2 and the supporting plate 4 of each pipe section 1 are coated with the same adsorbent 5. Preferably, there are three supporting plates 4 at equal intervals.

The heavy metal separating device further includes: the plurality of connectors 3; and a plurality of the pipe section 1 are connected by the connectors 3.

The heavy metal separating device further includes a plurality of on-line water quality monitoring devices. The connector 3 is provided with a water quality monitoring port 6. A probe of the on-line water quality monitoring device is arranged inside the connector 3 through the water quality monitoring port 6. The on-line water quality monitoring device is used for detecting and displaying the concentration of heavy metal ions in wastewater flowing into the connector 3. When it is detected by the on-line water quality monitoring device that the concentration of heavy metal ions in wastewater exceeds an allowable discharge concentration of corresponding heavy metal ions, a pipe section is replaced with a new same one, and the heavy metal can be recycled in the replaced pipe section 1. According to the actual situation of each main body discharging wastewater, the on-line water quality monitoring device can compare the detected concentration of heavy metal ions in wastewater with the allowable discharge concentration of corresponding heavy metal ions, and when the concentration of heavy metal ions in wastewater exceeds the allowable discharge concentration of corresponding heavy metal ions, the on-line water quality monitoring device can display alarm information.

A method for determining the length of the pipe section 1 includes: before the heavy metal separating device is used, sampling wastewater discharged from each factory main body, and then respectively performing simulation experiments to determine whether to increase the length of the pipe section 1 according to a comparison result between the concentration of heavy metal ions in the wastewater detected by the on-line water quality monitoring device and the allowable discharge concentration of corresponding heavy metal ions.

Preferably, the concentration of heavy metal ions in the wastewater flowing into the connector 3 can also be manually detected, and the result of detection is manually compared with the allowable discharge concentration of corresponding heavy metal ions.

An example of the present invention further provides a parameter determining method for a pipe section of a heavy metal separating device. The parameter determining method includes the following steps.

According to a design flow of the pipe section and codes for design of outdoor wastewater engineering, a relation between a diameter of the pipe section and a depth of wastewater in the pipe section is determined, specifically including the following steps.

According to the design flow of the pipe section and the codes for design of outdoor wastewater engineering, the relation between the diameter of the pipe section and the depth of wastewater in the pipe section is determined as follows:

$$Q = A υ$$

$$A = 2 \times [ \frac{π - θ}{2} \times {( \frac{D}{2} )}^{2} + \frac{1}{2} \times \frac{D}{2} \times ( h - \frac{D}{2} ) \times \frac{h - \frac{D}{2}}{D \text{/} 2} ]$$

$$υ = \frac{1}{n} {R}^{\frac{2}{3}} {I}^{\frac{1}{2}}$$

where Q is the design flow of the pipe section, A is an effective cross-sectional area of water in the pipe section, υ is a flow rate of water in the pipe section, n is a roughness coefficient of the pipe section, I is a hydraulic slope of water in the pipe section, R is a hydraulic radius of water in the pipe section,

$$R = \frac{A}{χ} ,$$

χ is a wetted perimeter of the pipe section,

$$χ = \frac{2 π - 2 θ}{2 π} \times π D ,$$

2θ is a central angle of the water surface in the pipe section,

$$θ = arccos \frac{h - \frac{D}{2}}{D \text{/} 2} ,$$

h is the depth of wastewater in the pipe section, and D is the diameter of the pipe section, as shown in FIG. 2. See GB 50014-2006 Code for Design of Outdoor Wastewater Engineering for details of codes for design of outdoor wastewater engineering.

An initial value of the diameter of the pipe section is set as a minimum pipe diameter threshold specified in the codes for design of outdoor wastewater engineering.

According to the relation between the diameter of the pipe section and the depth of wastewater in the pipe section, the wastewater depth corresponding to the pipe section diameter is calculated.

The fullness of the pipe section is determined according to the depth of wastewater, specifically including the following steps:

According to the depth of wastewater, fullness of the pipe section is calculated by using formula

$$ω = \frac{h}{D} ,$$

where ω is the fullness of the pipe section, h is the depth of wastewater in the pipe section and D is the diameter of the pipe section.

According to the diameter of the pipe section, maximum design fullness corresponding to the diameter of the pipe section is obtained by looking up a relation table of the pipe diameter and the maximum design fullness, specifically including the following steps. The relation between the pipe diameter and the maximum design fullness is shown in Table 1.

TABLE 1
Relation between the pipe diameter and the maximum design fullness

| Pipe diameter or ditch depth(mm) | Maximum design fullness |
|---|---|
| 200-300 | 0.55 |
| 350-450 | 0.65 |
| 500-900 | 0.70 |
| ≥1000 | 0.75 |

The pipe diameter is the diameter of the pipe section 1.

Whether the fullness is greater than the maximum design fullness is determined to obtain a first determining result.

If the first determining result indicates that the fullness is greater than the maximum design fullness, the diameter of the pipe section is increased to obtain an updated pipe section diameter, and the process returns to the step of calculating the wastewater depth corresponding to the pipe section diameter according to the relation.

If the first determining result indicates that the fullness is less than or equal to the maximum design fullness, the pipe section diameter is output as a diameter value of the pipe section.

According to the diameter value of the pipe section and preset ratios of radiuses of the multilayer pipes, the number of pipe layers of the pipe section and the diameter of each pipe layer are determined, specifically including the following steps.

An initial value of the preset number of pipe layers is 1.

According to the diameter value of the pipe section and the preset ratios of radiuses of the multilayer pipes, the radius of the innermost pipe corresponding to the number of pipe layers is determined by using formula 2r_{N}=D, where r_{N} is the radius of the outermost pipe, and D is the diameter of the pipe section. Preferably, in order to increase the contact area between wastewater and an adsorbent 5 in the pipe section as much as possible without causing blockage of the pipe, the ratios of the radiuses of the pipes 2 from the innermost pipe to the outermost pipe are sequentially set to r₁:r₂:r₃: . . . r_{N}=1:2:3: . . . : N, r₁ is the radius of the innermost pipe, r₂ is the radius of the second layer of pipe, r₃ is the radius of the third layer of pipe, r_{N} is the radius of the outermost pipe, and N is the number of pipe layers. According to the ratio of the radiuses of the pipes, r_{N}=Nr₁ can be obtained, thus obtaining 2Nr₁=D.

Whether the radius of the innermost pipe is greater than 200 mm is determined to obtain a second determining result.

If the second determining result indicates that the radius of the innermost pipe is greater than 200 mm, the number of pipe layers is increased by 1, the process returns to the step of determining the radius of the innermost pipe corresponding to the number of pipe layers according to the diameter value of the pipe section and the preset ratios of radiuses of the multilayer pipes.

If the second determining result indicates that the radius of the innermost pipe is less than or equal to 200 mm, the number of pipe layers is output.

According to the number of pipe layers, the diameter value of the pipe section and the preset ratios of radiuses of the multilayer pipes, the diameter of each pipe layer of the pipe section is determined in accordance with formulas 2Nr₁=D and r₁:r₂:r₃: . . . r_{N}=1:2:3: . . . : N, i.e.,

$${r}_{2} = 2 \times \frac{D}{2 N} , {r}_{3} = 3 \times \frac{D}{2 N} , … , {r}_{N} = N \times \frac{D}{2 N} .$$

The present invention removes heavy metal ions in wastewater by an adsorption method, the principle of which is to remove heavy metals by utilizing the adsorption effect of solid materials with porosity or high specific surface area on the heavy metal ions in wastewater. The adsorption method is suitable for filtering wastewater containing various heavy metal ions, and adsorbents have wide sources and low costs.

According to the present invention, the heavy metal adsorbent is coated onto a drainage pipe, so that heavy metals are separated while the wastewater is conveyed, the area occupied by wastewater treatment facilities can be greatly reduced, and heavy metal ions in the wastewater can be efficiently separated.

In the present invention, the number of layers of internal pipes and flat supporting plates can also be increased, and inner and outer surfaces thereof are coated with an adsorbent, so that the contact area between wastewater and the adsorbent is greatly increased, thereby facilitating the removal of heavy metal ions, and ensuring the removal effect of heavy metal ions. Moreover, the length and number of pipe sections and the types of adsorbents coated inside can be determined according to the actual situation of heavy metals in wastewater, the effect of adsorbents and economic factors, so that the present invention has universality for most wastewater containing heavy metals. In addition, the present invention has the advantages of simple structure, easiness in operation, small investment, free assembly, good treatment effect, capability of removing and recycling heavy metals in the wastewater transportation process, etc.

Specific examples are used herein for illustration of the principles and implementations of the present invention. The description of the foregoing examples is used to help understand the method of the present invention and the core idea thereof. In addition, those of ordinary skill in the art can make various modifications in terms of specific implementations and scope of application in accordance with the teachings of the present invention. In conclusion, the content of the present specification shall not be construed as a limitation to the present invention.

What is claimed is:

1. A heavy metal separating device, comprising a plurality of pipe sections and a plurality of adsorbents;
wherein the pipe sections each comprise multilayer pipes;
the plurality of pipe sections are connected end to end; and
each of the pipe sections is coated with one adsorbent; and the adsorbent is coated onto the multilayer pipes of the pipe section.

2. The heavy metal separating device according to claim 1, wherein a plurality of supporting plates are arranged between adjacent pipes of the pipe section; and the supporting plates are coated with the adsorbents.

3. The heavy metal separating device according to claim 1, further comprising a plurality of connectors;
wherein the plurality of the pipe sections are connected by the connectors.

4. The heavy metal separating device according to claim 3, further comprising a plurality of on-line water quality monitoring devices;
wherein the connector is provided with a water quality monitoring port; a probe of the on-line water quality monitoring device is arranged inside the connector through the water quality monitoring port; the on-line water quality monitoring device is used for detecting and displaying the concentration of heavy metal ions in wastewater flowing into the connector.

5. A parameter determining method for a pipe section of the heavy metal separating device according to claim 4, comprising:
according to a design flow of the pipe section and codes for design of outdoor wastewater engineering, determining a relation between a diameter of the pipe section and a depth of wastewater in the pipe section;
setting an initial value of the diameter of the pipe section as a minimum pipe diameter threshold specified in the codes for design of outdoor wastewater engineering;
according to the relation, calculating the wastewater depth corresponding to the pipe section diameter;
determining fullness of the pipe section according to the depth of wastewater;
according to the diameter of the pipe section, obtaining maximum design fullness corresponding to the diameter of the pipe section by looking up a relation table of the pipe diameter and the maximum design fullness;
determining whether the fullness is greater than the maximum design fullness to obtain a first determining result;
if the first determining result indicates that the fullness is greater than the maximum design fullness, increasing the diameter of the pipe section to obtain an updated pipe section diameter, and returning to the step of calculating the wastewater depth corresponding to the pipe section diameter according to the relation;
if the first determining result indicates that the fullness is less than or equal to the maximum design fullness, outputting the pipe section diameter as a diameter value of the pipe section; and
according to the diameter value of the pipe section and preset ratios of radiuses of the multilayer pipes, determining the number of pipe layers of the pipe section and the diameter of each pipe layer.

6. The parameter determining method for a pipe section of the heavy metal separating device according to claim 5, wherein the determining a relation between a diameter of the pipe section and a depth of wastewater in the pipe section according to a design flow of the pipe section and codes for design of outdoor wastewater engineering specifically comprises:
according to the design flow of the pipe section and the codes for design of outdoor wastewater engineering, determining the relation between the diameter of the pipe section and the depth of wastewater in the pipe section as follows:
$$Q = A υ$$
$$A = 2 \times [ \frac{π - θ}{2} \times {( \frac{D}{2} )}^{2} + \frac{1}{2} \times \frac{D}{2} \times ( h - \frac{D}{2} ) \times \frac{h - \frac{D}{2}}{D \text{/} 2} ]$$
$$υ = \frac{1}{n} {R}^{\frac{2}{3}} {I}^{\frac{1}{2}}$$
wherein Q is the design flow of the pipe section, A is an effective cross-sectional area of water in the pipe section, υ is a flow rate of water in the pipe section, n is a roughness coefficient of the pipe section, I is a hydraulic slope of water in the pipe section, R is a hydraulic radius of water in the pipe section,
$$R = \frac{A}{χ} ,$$
χ is a wetted perimeter of the pipe section,
$$χ = \frac{2 π - 2 θ}{2 π} \times π D ,$$
2θ is a central angle of the water surface in the pipe section,
$$θ = arccos \frac{h - \frac{D}{2}}{D \text{/} 2} ,$$
h is the depth of wastewater in the pipe section, and D is the diameter of the pipe section.

7. The parameter determining method for a pipe section of the heavy metal separating device according to claim 5, wherein the determining fullness of the pipe section according to the depth of wastewater specifically comprises:
calculating fullness of the pipe section by using formula
$$ω = \frac{h}{D}$$
according to the depth of wastewater;
wherein ω is the fullness of the pipe section, h is the depth of wastewater in the pipe section and D is the diameter of the pipe section.

8. The parameter determining method for a pipe section of the heavy metal separating device according to claim 5, wherein the determining the number of pipe layers of the pipe section and the diameter of each pipe layer according to the diameter value of the pipe section and preset ratios of radiuses of the multilayer pipes specifically comprises:
setting an initial value of the preset number of pipe layers to 1;
according to the diameter value of the pipe section and the preset ratios of radiuses of the multilayer pipes, determining the radius of the innermost pipe corresponding to the number of pipe layers;
determining whether the radius of the innermost pipe is greater than 200 mm to obtain a second determining result;
if the second determining result indicates that the radius of the innermost pipe is greater than 200 mm, increasing the number of pipe layers by 1, and returning to the step of determining the radius of the innermost pipe corresponding to the number of pipe layers according to the diameter value of the pipe section and the preset ratios of radiuses of the multilayer pipe;
if the second determining result indicates that the radius of the innermost pipe is less than or equal to 200 mm, outputting the number of pipe layers; and
according to the number of layers of the pipe, the diameter value of the pipe section and the preset ratios of radiuses of the multilayer pipes, determining the diameter of each pipe layer of the pipe section.

9. A parameter determining method for a pipe section of the heavy metal separating device according to claim 2, comprising:
according to a design flow of the pipe section and codes for design of outdoor wastewater engineering, determining a relation between a diameter of the pipe section and a depth of wastewater in the pipe section;
setting an initial value of the diameter of the pipe section as a minimum pipe diameter threshold specified in the codes for design of outdoor wastewater engineering;
according to the relation, calculating the wastewater depth corresponding to the pipe section diameter;
determining fullness of the pipe section according to the depth of wastewater;
according to the diameter of the pipe section, obtaining maximum design fullness corresponding to the diameter of the pipe section by looking up a relation table of the pipe diameter and the maximum design fullness;
determining whether the fullness is greater than the maximum design fullness to obtain a first determining result;
if the first determining result indicates that the fullness is greater than the maximum design fullness, increasing the diameter of the pipe section to obtain an updated pipe section diameter, and returning to the step of calculating the wastewater depth corresponding to the pipe section diameter according to the relation;
if the first determining result indicates that the fullness is less than or equal to the maximum design fullness, outputting the pipe section diameter as a diameter value of the pipe section; and
according to the diameter value of the pipe section and preset ratios of radiuses of the multilayer pipes, determining the number of pipe layers of the pipe section and the diameter of each pipe layer.

10. A parameter determining method for a pipe section of the heavy metal separating device according to claim 3, comprising:
according to a design flow of the pipe section and codes for design of outdoor wastewater engineering, determining a relation between a diameter of the pipe section and a depth of wastewater in the pipe section;
setting an initial value of the diameter of the pipe section as a minimum pipe diameter threshold specified in the codes for design of outdoor wastewater engineering;
according to the relation, calculating the wastewater depth corresponding to the pipe section diameter;
determining fullness of the pipe section according to the depth of wastewater;
according to the diameter of the pipe section, obtaining maximum design fullness corresponding to the diameter of the pipe section by looking up a relation table of the pipe diameter and the maximum design fullness;
determining whether the fullness is greater than the maximum design fullness to obtain a first determining result;
if the first determining result indicates that the fullness is greater than the maximum design fullness, increasing the diameter of the pipe section to obtain an updated pipe section diameter, and returning to the step of calculating the wastewater depth corresponding to the pipe section diameter according to the relation;
if the first determining result indicates that the fullness is less than or equal to the maximum design fullness, outputting the pipe section diameter as a diameter value of the pipe section; and
according to the diameter value of the pipe section and preset ratios of radiuses of the multilayer pipes, determining the number of pipe layers of the pipe section and the diameter of each pipe layer.

11. A parameter determining method for a pipe section of the heavy metal separating device according to claim 4, comprising:
according to a design flow of the pipe section and codes for design of outdoor wastewater engineering, determining a relation between a diameter of the pipe section and a depth of wastewater in the pipe section;
setting an initial value of the diameter of the pipe section as a minimum pipe diameter threshold specified in the codes for design of outdoor wastewater engineering;
according to the relation, calculating the wastewater depth corresponding to the pipe section diameter;
determining fullness of the pipe section according to the depth of wastewater;
according to the diameter of the pipe section, obtaining maximum design fullness corresponding to the diameter of the pipe section by looking up a relation table of the pipe diameter and the maximum design fullness;
determining whether the fullness is greater than the maximum design fullness to obtain a first determining result;
if the first determining result indicates that the fullness is greater than the maximum design fullness, increasing the diameter of the pipe section to obtain an updated pipe section diameter, and returning to the step of calculating the wastewater depth corresponding to the pipe section diameter according to the relation;
if the first determining result indicates that the fullness is less than or equal to the maximum design fullness, outputting the pipe section diameter as a diameter value of the pipe section; and
according to the diameter value of the pipe section and preset ratios of radiuses of the multilayer pipes, determining the number of pipe layers of the pipe section and the diameter of each pipe layer.

12. The parameter determining method for a pipe section of the heavy metal separating device according to claim 6, wherein the determining a relation between a diameter of the pipe section and a depth of wastewater in the pipe section according to a design flow of the pipe section and codes for design of outdoor wastewater engineering specifically comprises:
according to the design flow of the pipe section and the codes for design of outdoor wastewater engineering, determining the relation between the diameter of the pipe section and the depth of wastewater in the pipe section as follows:
$$Q = A υ$$
$$A = 2 \times [ \frac{π - θ}{2} \times {( \frac{D}{2} )}^{2} + \frac{1}{2} \times \frac{D}{2} \times ( h - \frac{D}{2} ) \times \frac{h - \frac{D}{2}}{D / 2} ]$$
$$υ = \frac{1}{n} {R}^{\frac{2}{3}} {I}^{\frac{1}{2}}$$
wherein Q is the design flow of the pipe section, A is an effective cross-sectional area of water in the pipe section, υ is a flow rate of water in the pipe section, n is a roughness coefficient of the pipe section, I is a hydraulic slope of water in the pipe section, R is a hydraulic radius of water in the pipe section,
$$R = \frac{A}{χ} ,$$
χ is a wetted perimeter of the pipe section,
$$χ = \frac{2 π - 2 θ}{2 π} \times π D ,$$
2θ is a central angle of the water surface in the pipe section,
$$θ = arccos \frac{h - \frac{D}{2}}{D / 2} ,$$
h is the depth of wastewater in the pipe section, and D is the diameter of the pipe section.

13. The parameter determining method for a pipe section of the heavy metal separating device according to claim 7, wherein the determining a relation between a diameter of the pipe section and a depth of wastewater in the pipe section according to a design flow of the pipe section and codes for design of outdoor wastewater engineering specifically comprises:
according to the design flow of the pipe section and the codes for design of outdoor wastewater engineering, determining the relation between the diameter of the pipe section and the depth of wastewater in the pipe section as follows:
$$Q = A υ$$
$$A = 2 \times [ \frac{π - θ}{2} \times {( \frac{D}{2} )}^{2} + \frac{1}{2} \times \frac{D}{2} \times ( h - \frac{D}{2} ) \times \frac{h - \frac{D}{2}}{D / 2} ]$$
$$υ = \frac{1}{n} {R}^{\frac{2}{3}} {I}^{\frac{1}{2}}$$
wherein Q is the design flow of the pipe section, A is an effective cross-sectional area of water in the pipe section, υ is a flow rate of water in the pipe section, n is a roughness coefficient of the pipe section, I is a hydraulic slope of water in the pipe section, R is a hydraulic radius of water in the pipe section,
$$R = \frac{A}{χ} ,$$
χ is a wetted perimeter of the pipe section,
$$χ = \frac{2 π - 2 θ}{2 π} \times π D ,$$
2θ is a central angle of the water surface in the pipe section,
$$θ = arccos \frac{h - \frac{D}{2}}{D / 2} ,$$
h is the depth of wastewater in the pipe section, and D is the diameter of the pipe section.

14. The parameter determining method for a pipe section of the heavy metal separating device according to claim 8, wherein the determining a relation between a diameter of the pipe section and a depth of wastewater in the pipe section according to a design flow of the pipe section and codes for design of outdoor wastewater engineering specifically comprises:
according to the design flow of the pipe section and the codes for design of outdoor wastewater engineering, determining the relation between the diameter of the pipe section and the depth of wastewater in the pipe section as follows:
$$Q = A υ$$
$$A = 2 \times [ \frac{π - θ}{2} \times {( \frac{D}{2} )}^{2} + \frac{1}{2} \times \frac{D}{2} \times ( h - \frac{D}{2} ) \times \frac{h - \frac{D}{2}}{D / 2} ]$$
$$υ = \frac{1}{n} {R}^{\frac{2}{3}} {I}^{\frac{1}{2}}$$
wherein Q is the design flow of the pipe section, A is an effective cross-sectional area of water in the pipe section, υ is a flow rate of water in the pipe section, n is a roughness coefficient of the pipe section, I is a hydraulic slope of water in the pipe section, R is a hydraulic radius of water in the pipe section,
$$R = \frac{A}{χ} ,$$
χ is a wetted perimeter of the pipe section,
$$χ = \frac{2 π - 2 θ}{2 π} \times π D ,$$
2θ is a central angle of the water surface in the pipe section,
$$θ = arccos \frac{h - \frac{D}{2}}{D / 2} ,$$
h is the depth of wastewater in the pipe section, and D is the diameter of the pipe section.

15. The parameter determining method for a pipe section of the heavy metal separating device according to claim 6, wherein the determining fullness of the pipe section according to the depth of wastewater specifically comprises:
calculating fullness of the pipe section by using formula
$$ω = \frac{h}{D}$$
according to the depth of wastewater;
wherein ω is the fullness of the pipe section, h is the depth of wastewater in the pipe section and D is the diameter of the pipe section.

16. The parameter determining method for a pipe section of the heavy metal separating device according to claim 7, wherein the determining fullness of the pipe section according to the depth of wastewater specifically comprises:
calculating fullness of the pipe section by using formula
$$ω = \frac{h}{D}$$
according to the depth of wastewater;
wherein ω is the fullness of the pipe section, h is the depth of wastewater in the pipe section and D is the diameter of the pipe section.

17. The parameter determining method for a pipe section of the heavy metal separating device according to claim 8, wherein the determining fullness of the pipe section according to the depth of wastewater specifically comprises:
calculating fullness of the pipe section by using formula
$$ω = \frac{h}{D}$$
according to the depth of wastewater;
wherein ω is the fullness of the pipe section, h is the depth of wastewater in the pipe section and D is the diameter of the pipe section.

18. The parameter determining method for a pipe section of the heavy metal separating device according to claim 6, wherein the determining the number of pipe layers of the pipe section and the diameter of each pipe layer according to the diameter value of the pipe section and preset ratios of radiuses of the multilayer pipes specifically comprises:
setting an initial value of the preset number of pipe layers to 1;
according to the diameter value of the pipe section and the preset ratios of radiuses of the multilayer pipes, determining the radius of the innermost pipe corresponding to the number of pipe layers;
determining whether the radius of the innermost pipe is greater than 200 mm to obtain a second determining result;
if the second determining result indicates that the radius of the innermost pipe is greater than 200 mm, increasing the number of pipe layers by 1, and returning to the step of determining the radius of the innermost pipe corresponding to the number of pipe layers according to the diameter value of the pipe section and the preset ratios of radiuses of the multilayer pipe;
if the second determining result indicates that the radius of the innermost pipe is less than or equal to 200 mm, outputting the number of pipe layers; and
according to the number of layers of the pipe, the diameter value of the pipe section and the preset ratios of radiuses of the multilayer pipes, determining the diameter of each pipe layer of the pipe section.

19. The parameter determining method for a pipe section of the heavy metal separating device according to claim 7, wherein the determining the number of pipe layers of the pipe section and the diameter of each pipe layer according to the diameter value of the pipe section and preset ratios of radiuses of the multilayer pipes specifically comprises:
setting an initial value of the preset number of pipe layers to 1;
according to the diameter value of the pipe section and the preset ratios of radiuses of the multilayer pipes, determining the radius of the innermost pipe corresponding to the number of pipe layers;
determining whether the radius of the innermost pipe is greater than 200 mm to obtain a second determining result;
if the second determining result indicates that the radius of the innermost pipe is greater than 200 mm, increasing the number of pipe layers by 1, and returning to the step of determining the radius of the innermost pipe corresponding to the number of pipe layers according to the diameter value of the pipe section and the preset ratios of radiuses of the multilayer pipe;
if the second determining result indicates that the radius of the innermost pipe is less than or equal to 200 mm, outputting the number of pipe layers; and
according to the number of layers of the pipe, the diameter value of the pipe section and the preset ratios of radiuses of the multilayer pipes, determining the diameter of each pipe layer of the pipe section.

20. The parameter determining method for a pipe section of the heavy metal separating device according to claim 8, wherein the determining the number of pipe layers of the pipe section and the diameter of each pipe layer according to the diameter value of the pipe section and preset ratios of radiuses of the multilayer pipes specifically comprises:
setting an initial value of the preset number of pipe layers to 1;
according to the diameter value of the pipe section and the preset ratios of radiuses of the multilayer pipes, determining the radius of the innermost pipe corresponding to the number of pipe layers;
determining whether the radius of the innermost pipe is greater than 200 mm to obtain a second determining result;
if the second determining result indicates that the radius of the innermost pipe is greater than 200 mm, increasing the number of pipe layers by 1, and returning to the step of determining the radius of the innermost pipe corresponding to the number of pipe layers according to the diameter value of the pipe section and the preset ratios of radiuses of the multilayer pipe;
if the second determining result indicates that the radius of the innermost pipe is less than or equal to 200 mm, outputting the number of pipe layers; and
according to the number of layers of the pipe, the diameter value of the pipe section and the preset ratios of radiuses of the multilayer pipes, determining the diameter of each pipe layer of the pipe section.
